(19) United States
(12) Patent Application Publication
(10) Pub. No.: US 2005/0062335 A1
(43) Pub. Date: Mar. 24, 2005

(54) Wheel spinner assembly for motorcycles

(76) Inventor: Carlos Odell, Baton Rouge, LA (US)

Correspondence Address: STITES & HARBISON PLLC, 1199 NORTH FAIRFAX STREET, SUITE 900, ALEXANDRIA, VA, 22314, US

(21) Appl. No.: 10/667,508

(22) Filed: Sep. 23, 2003

(51) Int. Cl. B60B 7/04

(52) U.S. Cl. 301/37.101; 301/37.26

(57) ABSTRACT

A wheel spinner assembly adapted to be mounted on a motorcycle wheel includes a hub that fits onto the central portion of the wheel rim assembly. A flanged member is mounted for rotation on one or more bearings supported on the hub. The flanged member includes a plurality of radially extending connector flanges. Individual spinner wings are removably and replaceably connected to the connector flanges so as to extend radially outwardly therefrom. An annular cap member is disposed adjacent to the bearing(s) in engagement with an end wall of the hub and holds the bearing(s) in place. Bolts extending through the cap member and the hub affix the assembly to the wheel rim assembly.

### FIELD OF THE INVENTION

The present invention generally relates to wheel spinner devices adapted to be mounted on vehicle wheels so as to rotate independently of the rotation of the wheel on which the spinner device is mounted, and, more particularly to wheel spinner devices for motorcycles.

### BACKGROUND OF THE INVENTION

A number of different spinner devices have been developed for automobiles and other automotive vehicles. Examples of patents relating to spinner and like devices for automotive vehicles include the following U.S. patents and patent applications: U.S. Pat. No. 6,554,370 to Fowlkes; U.S. Application No. 2002/0036426 to Fowlkes; U.S. Application No. 2003/0102712 to Fitzgerald; U.S. Pat. No. 3,722,958 to Marshall; U.S. Pat. No. 5,290,094 to Gragg; U.S. Pat. No. 4,562,516 to Chastain; U.S. Pat. No. 4,121,851 to Finkenbiner; U.S. Pat. No. 5,584,537 to Miansian; U.S. Pat. No. 3,597,003 to Kraus; U.S. Pat. No. 3,155,430 to Schindler; U.S. Pat. No. 3,158,946 to Upchurch; U.S. Pat. No. 3,219,391 to Hettinger; and U.S. Pat. No. 1,699,831 to Braucher.

There are also a large number of design patents in this field including the following U.S. design patents: U.S. Pat. No. D424,502; U.S. Pat. No. D399,475; U.S. Pat. No. D303,103; U.S. Pat. No. D252,873; U.S. Pat. No.D379,080; U.S. Pat. No.D373,103; U.S. Pat. No. D362,233; U.S. Pat. No. D396,683; U.S. Pat. No.D432,485; U.S. Pat. No. D379,959; U.S. Pat. No.D372,451; U.S. Pat. No.D380,185; U.S. Pat. No. D434,713; and U.S. Pat. No.D385,247.

Mounting a spinner device on a motorcycle wheel presents special problems because of the nature of a motorcycle wheel rim and the presence of the brake in the area of the normal mounting site, and to date, to the knowledge of applicant, spinners for motorcycles have not been commercially available. Another area of interest with respect to spinner devices is design variability. In this regard, as is evident from the large number of design patents listed above, there are many different available wheel spinner designs, and because wheel spinners are used essentially because of their decorative nature, variety is desirable in the decorative appearance presented. With the spinner devices currently available, in order to change the shape and configuration of the spinner portion, i.e., the configuration of the decorative radiating vanes or wings of the spinner, a user must purchase an entirely new spinner device.

### SUMMARY OF THE INVENTION

In accordance with the invention, a wheel spinner assembly or device is provided which is particularly adapted for use with motorcycles. An important advantage of the wheel spinner device of the invention is that the individual spinner wings or vanes are readily removable so that different shapes and forms of vanes, and different numbers of vanes, can be used with the same basic spinner assembly so that, i.e., new spinner wings or vanes can be readily substituted for the existing wings or vanes without altering the rest of the wheel spinner assembly. In addition, if needed, the wheel spinner assembly can be readily disassembled so as to permit the bearings to be greased or for other purposes.

In accordance with one aspect of the invention, there is provided a wheel spinner assembly adapted to be mounted on a motorcycle wheel including a wheel rim assembly including a central outwardly projecting portion, said wheel spinner assembly comprising:
a hub member including an outer circumferential surface, and an end wall including a plurality of bolt holes adapted to enable affixing of the hub member to the central portion of the wheel rim assembly, said outer circumferential surface including a reduced diameter portion adjacent to said end surface;
at least one annular bearing mounted on said reduced diameter portion;
a plurality of spinner wings;
a flanged member mounted for rotation on said at least one annular bearing and including an annular portion having an outer circumferential surface, said flanged member further including a plurality of radially extending connector flanges disposed in circumferentially spaced relation and extending radially outwardly from said outer circumferential surface, each of said spinner wings being removably connected to a respective one of said connector flanges so as to extend radially outwardly therefrom;
an annular cap member disposed adjacent to said at least one annular bearing, in engagement with, and extending substantially parallel to said end wall of said hub member, said cap member including a like plurality of bolt holes aligned with the bolt holes of the hub member; and
a plurality of bolts extending through the bolt holes of the hub member and the bolt holes of the cap member so as to affix the assembly to the central portion of the wheel rim assembly.

In one preferred embodiment, the at least one bearing comprises an annular array of ball bearings.

In another preferred embodiment, the at least one bearing comprises a single ring bearing.

In yet another embodiment, the at least one bearing comprises first and second annular bearings and the annular portion of said flanged member further includes an inner circumferential surface and an annular rib projecting radially inwardly from said inner surface, said rib including opposed lateral surfaces respectively engaging said first and second annular bearings.

Preferably, the end wall of said hub member includes a central opening and said cap member includes a central opening in alignment with the central opening of said end wall.

Advantageously, the cap member is substantially planar.

Preferably, the flanges each include a central keyway and first and second fastener holes disposed on opposite sides of said keyway.

In accordance with another related aspect of the invention, there is provided a wheel spinner assembly adapted to be mounted on a motorcycle wheel including a wheel rim assembly including a central outwardly projecting portion, said wheel spinner assembly comprising:
a hub member including an outer circumferential surface and adapted to be mounted on the central portion of the wheel rim assembly of the motorcycle wheel;
at least one annular bearing means mounted on the outer circumferential surface of said hub member;
a plurality of removable and replaceable spinner wings;
a flanged member mounted for rotation on said at least one annular bearing means and including a plurality of radially extending connector flanges disposed in circumferentially spaced relation, each of said plurality of spinner wings being removably connected to a respective one of said connector flanges so as to extend radially outwardly therefrom; and
at least one fastener for affixing the wheel spinner assembly to the central portion of the wheel rim assembly.

As above, in one preferred embodiment, the at least one annular bearing means comprises first and second annular bearings and said flanged member further includes an inner circumferential surface and an annular rib projecting radially inwardly from said inner surface, said rib including opposed lateral surfaces respectively engaging said first and second annular bearings.

In another preferred embodiment, the at least one annular bearing means comprises at least one ring bearing, the spinner assembly further comprises an end cap disposed adjacent to said at least one ring bearing in engagement with said end wall of said hub member, and the end cap comprises a substantially planar annular member. Advantageously, the hub member includes a transverse end wall engaged by said end cap. Preferably, the end wall of said hub member includes a central opening and said end cap includes a central opening in alignment with the central opening of said end wall.

As above, the flanges advantageously each include a central keyway and first and second fastener holes disposed on opposite sides of said keyway.

In accordance with a further related aspect of the invention, there is provided a wheel spinner assembly adapted to be mounted on a motorcycle wheel including a wheel rim assembly including a central outwardly projecting portion, said wheel spinner assembly comprising:
a hub member adapted to be mounted on the central projecting portion of the wheel rim assembly of the motorcycle wheel;
bearing means mounted on said hub member;
a plurality of removable and replaceable spinner wings;
a flanged member mounted for rotation on said hub member by said bearing means, said flanged member further including a plurality of radially extending connector flanges disposed in circumferentially spaced relation, each of said spinner wings being removably connected to a respective one of said connector flanges so as to extend radially outwardly therefrom; and
fastener means for affixing the wheel spinner assembly to the central portion of the wheel rim assembly.

As above, in one important embodiment, the wheel spinner assembly further comprises an end cap member disposed adjacent to the bearing means for retaining said bearing means in place. The hub member preferably includes a transverse end wall engaged by the end cap. Advantageously, the end wall of said hub member includes a central opening and said end cap includes a central opening in alignment with the central opening of said end wall.

In one preferred embodiment, the bearing means comprises a single ring bearing.

In another preferred embodiment, the bearing means comprises an annular array of ball bearings.

In yet another preferred embodiment, the bearing means comprises first and second annular bearings, and wherein said flanged member further includes an inner circumferential surface and an annular rib projecting radially inwardly from said inner surface, said rib including opposed lateral surfaces respectively engaging said first and second annular bearings.

As above, the flanges each include a central keyway and first and second fastener holes disposed on opposite sides of said keyway.

In one preferred embodiment, the hub member includes an end wall and said fastener means comprises a plurality of fastener elements extending through said end wall longitudinally of said hub member.

In another preferred embodiment, the fastener means comprises a plurality of fastener elements extending radially through said hub member.

Further features and advantages of the present invention will be set forth in, or apparent from, the detailed description of preferred embodiments thereof which follows.

### BRIEF DESCRIPTION OF THE DRAWINGS

FIG. 1 is an exploded perspective view of a motorcycle wheel spinner assembly in accordance with a preferred embodiment of the invention;

FIG. 2 is a cross sectional view of the spinner assembly of FIG. 1, showing the spinner assembly mounted on the projecting portion of a motorcycle wheel rim assembly;

FIG. 3 is a broken away detail of a cross sectional view of a further embodiment of the invention, showing a different bearing arrangement;

FIG. 4 is a broken away detail of another embodiment of the invention, showing a further bearing arrangement; and

FIG. 5 is a side elevational view, partially broken away, of a hub member in accordance with yet another embodiment of the invention.

### DESCRIPTION OF THE PREFERRED EMBODIMENTS

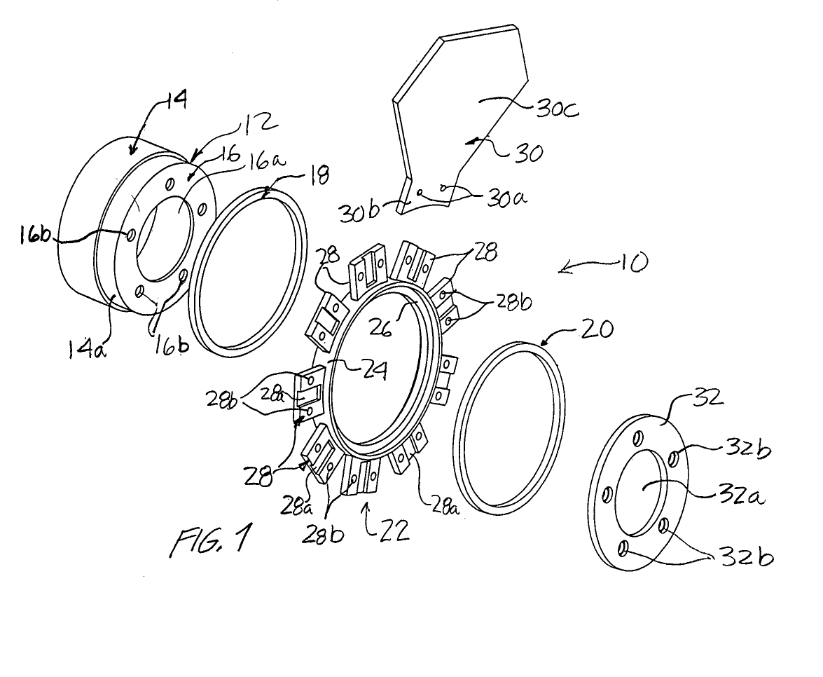

Referring to FIG. 1, there is shown an exploded perspective view of a spinner assembly in accordance with a preferred embodiment of the invention. The assembly, which is generally denoted 10, includes a hub member or hub 12 of a hollow cylindrical shape including an outer circumferential or peripheral surface 14. Hub member 12 is partially closed at one end by a transversely extending end portion or end wall 16 including a central opening 16a and a plurality of circumferentially spaced bolt holes 16b (i.e., five bolt holes in the illustrated embodiment). The outer surface 14 of hub member 14 includes a portion 14a of reduced diameter located adjacent to end portion 16.

In this embodiment, first and second annular bearings or bearing rings 18 and 20 are adapted to be mounted on reduced diameter surface portion 14a of hub member 12, in axially spaced relation.

A flanged annular member or flair wheel 22 is adapted to be mounted for rotation on annular bearings 18 and 20. Member 22 includes an annular portion 24 including an inwardly projecting, centrally located, circumferentially extending rib 26 so that annular portion 24 is generally T-shaped in cross section (see FIG. 2). Rib 26 is adapted to be disposed between bearings 18 and 20 and, to this end, the lateral surfaces of rib 26 are polished to enable smooth rotation of flair wheel 22. A plurality of flanges 28 extends radially outwardly from the outer surface of annular portion 24. In the embodiment illustrated, eight flanges 28 are employed although this number may, of course, be varied. Each flange 28 includes a central keyway 28a having a pair of bolt or screw holes 28b located on opposite sides thereof used to affix a respective spinner wing or vane thereto.

One such spinner wing is indicated at 30 in FIG. 1 and includes a spaced pair of bolt or screw holes 30a which cooperate with bolt or screw holes 28b in securing spinner wing 30 to a corresponding flange 28. Although it will be appreciated that the shape of the spinner wings can vary within wide limits, in the illustrated embodiment, the spinner wing 30 includes a base portion 30b in which holes 30a are formed and a main portion 32c having angled sides and a flat top edge.

It will also be understood that the number of spinner wings used can also vary, and that this variation can be achieved by varying the number of spinner wings attached to flair wheel 22 and/or by varying the number of flanges 30 provided on flair wheel 22, i.e., by redesigning flair wheel 22 to have a greater or lesser number of flanges 30.

An annular end plate or end cap member 32 of a substantially flat or planar shape includes a central opening 32a and a plurality of circumferentially spaced bolt holes 32b which, in use, are aligned with bolt holes 16a of end wall 16 of hub 12.

Referring to FIG. 2, the spinner assembly 10 is shown as assembled and mounted on the central projecting portion P of the wheel rim assembly of a motorcycle wheel. As shown, hub member 12 fits over projecting portion P and is secured thereto by bolts 23 which extend through the aligned bolt holes 32b of cap member or plate 32 and bolt holes 16b of a hub member 12 (these bolt holes 32b and 16b being best seen in FIG. 1). Spinner wings or vanes 30 are removably affixed to flanges 28 of flair wheel 22 by suitable removable fasteners, denoted 36, such as bolts, screws or the like.

As illustrated, spinner wings or vanes 30 extend radially outwardly from flair wheel 22 in a plane substantially parallel to the plane of the spokes (not shown) of the corresponding motorcycle wheel in spaced relation to the spokes, and within the outer annular rim portion (not shown) of the wheel rim on which the tire is mounted.

Spinner wings or vanes 30, and, in particular, the associated flair wheel 22 to which wings 30 are affixed, rotate on bearings 18 and 20 independently of the rotation of the motorcycle wheel, and will thus continue to rotate, i.e., spin around hub member 12, after the motorcycle is brought to a stop and the corresponding motorcycle wheel is stationary.

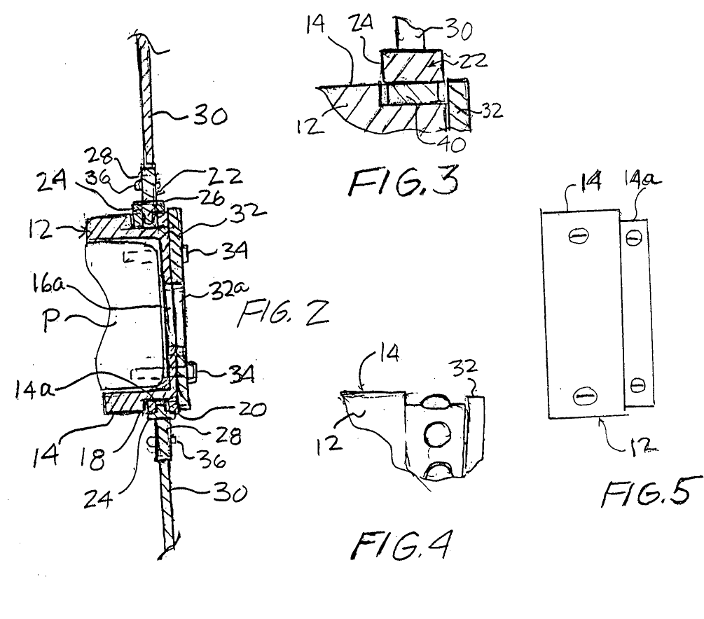

Referring to FIG. 3, a detail of a further embodiment of the invention is shown. FIG. 3 is similar to a portion of FIG. 2 and like elements have been given the same reference numerals. The embodiment of FIG. 3 differs from that of FIG. 2 in that bearings 18 and 20 are replaced by a single annular or ring bearing 40 and the annular portion 24 of flair wheel 22 sides on ring bearing 40. It will be appreciated that, in contrast to an automobile, wherein a spinner is attached to one side of a wheel, two spinners can be provided for each motorcycle wheel. Thus, reducing the number of parts by using a single annular bearing can be critical, particularly where, as here, cost is of a prime concern.

Referring to FIG. 4, a further embodiment is shown. This embodiment is similar to that of FIG. 3 except that ring bearing 40 is replaced by an annular bearing array 42 of ball bearings 44. Flair wheel 22 (not shown in FIG. 4) rides on ball bearings 44 and the operation is otherwise similar to that described above. An end cap is not required with this embodiment but may be used where a separate bearing race (not shown) is used to mount the ball bearings 44.

Referring to FIG. 5, a further embodiment of central hub or hub member 12 is shown. For some motorcycles, such as Harley-Davidson custom bikes, an arrangement as shown wherein the fasteners, such as screws 46 of FIG. 5, are directed radially, rather than axially as shown for fasteners 23 in FIGS. 1 and 2, is suitable for securing the hub member 12 to the projecting portion of the motorcycle wheel rim assembly.

As indicated above, spinners of all types (i.e., those for automobiles and those for other automotive vehicles) are, in essence, decorative in nature and the capability provided by the present invention of being able to readily affix or attach different spinner wings or vanes or sets of such wings to the central flair wheel enables the overall appearance of the spinner assembly to be readily varied. This capability also enables the spinning effect presented, i.e., the appearance presented by the spinning wings or vanes, to be varied depending on the types of spinner wings or vanes that are used.

Although the invention has been described above in relation to preferred embodiments thereof, it will be understood by those skilled in the art that variations and modifications can be effected in these preferred embodiments without departing from the scope and spirit of the invention.

1. A wheel spinner assembly adapted to be mounted on a motorcycle wheel including a wheel rim assembly including a central outwardly projecting portion, said wheel spinner assembly comprising:
a hub member including an outer circumferential surface, and an end wall including a plurality of bolt holes adapted to enable affixing of the hub member to the central portion of the wheel rim assembly, said outer circumferential surface including a reduced diameter portion adjacent to said end surface;
at least one annular bearing mounted on said reduced diameter portion;
a plurality of spinner wings;
a flanged member mounted for rotation on said at least one annular bearing and including an annular portion having an outer circumferential surface, said flanged member further including a plurality of radially extending connector flanges disposed in circumferentially spaced relation and extending radially outwardly from said outer circumferential surface, each of said spinner wings being removably connected to a respective one of said connector flanges so as to extend radially outwardly therefrom;
an annular cap member disposed adjacent to said at least one annular bearing, in engagement with, and extending substantially parallel to said end wall of said hub member, said cap member including a like plurality of bolt holes aligned with the bolt holes of the hub member; and
a plurality of bolts extending through the bolt holes of the hub member and the bolt holes of the cap member so as to affix the assembly to the central portion of the wheel rim assembly.

2. A wheel spinner assembly as claimed in claim 1 wherein said at least one bearing comprises an annular array of ball bearings.

3. A wheel spinner assembly as claimed in claim 1 wherein said at least one bearing comprises a single ring bearing.

4. A wheel spinner assembly as claimed in claim 1 wherein said at least one bearing comprises first and second annular bearings and said annular portion of said flanged member further includes an inner circumferential surface and an annular rib projecting radially inwardly from said inner surface, said rib including opposed lateral surfaces respectively engaging said first and second annular bearings.

5. A wheel spinner assembly as claimed in claim 1 wherein said end wall of said hub member includes a central opening and said cap member includes a central opening in alignment with the central opening of said end wall.

6. A wheel spinner assembly as claimed in claim 1 wherein said cap member is substantially planar.

7. A wheel spinner assembly as claimed in claim 1 wherein said flanges each include a central keyway and first and second fastener holes disposed on opposite sides of said keyway.

8. A wheel spinner assembly adapted to be mounted on a motorcycle wheel including a wheel rim assembly including a central outwardly projecting portion, said wheel spinner assembly comprising:
a hub member including an outer circumferential surface and adapted to be mounted on the central portion of the wheel rim assembly of the motorcycle wheel;
at least one annular bearing means mounted on the outer circumferential surface of said hub member;
a plurality of removable and replaceable spinner wings;
a flanged member mounted for rotation on said at least one annular bearing means and including a plurality of radially extending connector flanges disposed in circumferentially spaced relation, each of said plurality of spinner wings being removably connected to a respective one of said connector flanges so as to extend radially outwardly therefrom; and
at least one fastener for affixing the wheel spinner assembly to the central portion of the wheel rim assembly.

9. A wheel spinner assembly as claimed in claim 8 wherein said at least one annular bearing means comprises first and second annular bearings and said flanged member further includes an inner circumferential surface and an annular rib projecting radially inwardly from said inner surface, said rib including opposed lateral surfaces respectively engaging said first and second annular bearings.

10. A wheel spinner assembly as claimed in claim 8 wherein said at least one annular bearing means comprises at least one ring bearing, wherein said spinner assembly further comprises an end cap disposed adjacent to said ring bearing means in engagement with said end wall of said hub member, and wherein said end cap comprises a substantially planar annular member.

11. A wheel spinner assembly as claimed in claim 10 wherein said hub member includes a transverse end wall engaged by said end cap.

12. A wheel spinner assembly as claimed in claim 11 wherein said end wall of said hub member includes a central opening and said end cap includes a central opening in alignment with the central opening of said end wall.

13. A wheel spinner assembly as claimed in claim 8 wherein said flanges each include a central keyway and first and second fastener holes disposed on opposite sides of said keyway.

14. A wheel spinner assembly adapted to be mounted on a motorcycle wheel including a wheel rim assembly including a central outwardly projecting portion, said wheel spinner assembly comprising:
a hub member adapted to be mounted on the central projecting portion of the wheel rim assembly of the motorcycle wheel;
bearing means mounted on said hub member;
a plurality of removable and replaceable spinner wings;
a flanged member mounted for rotation on said hub member by said bearing means, said flanged member further including a plurality of radially extending connector flanges disposed in circumferentially spaced relation, each of said spinner wings being removably connected to a respective one of said connector flanges so as to extend radially outwardly therefrom; and
fastener means for affixing the wheel spinner assembly to the central portion of the wheel rim assembly.

15. A wheel spinner assembly as claimed in claim 14 further comprising an end cap member disposed adjacent to said bearing means for retaining said bearing means in place.

16. A wheel spinner assembly as claimed in claim 14 wherein said bearing means comprises a single ring bearing.

17. A wheel spinner assembly as claimed in claim 14 wherein said bearing means comprises an annular array of ball bearings, and.

18. A wheel spinner assembly as claimed in claim 14 wherein said bearing means comprises first and second annular bearings, and wherein said flanged member further includes an inner circumferential surface and an annular rib projecting radially inwardly from said inner surface, said rib including opposed lateral surfaces respectively engaging said first and second annular bearings.

19. A wheel spinner assembly as claimed in claim 15 wherein said hub member includes a transverse end wall engaged by said end cap.

20. A wheel spinner assembly as claimed in claim 19 wherein said end wall of said hub member includes a central opening and said end cap includes a central opening in alignment with the central opening of said end wall.

21. A wheel spinner assembly as claimed in claim 14 wherein said flanges each include a central keyway and first and second fastener holes disposed on opposite sides of said keyway.

22. A wheel spinner assembly as claimed in claim 14 wherein said hub member includes an end wall and said fastener means comprises a plurality of fastener elements extending through said end wall longitudinally of said hub member.

23. A wheel spinner assembly as claimed in claim 14 wherein said fastener means comprises a plurality of fastener elements extending radially through said hub member.
